(19) United States
(12) Patent Application Publication
(10) Pub. No.: US 2025/0144952 A1
(43) Pub. Date: May 8, 2025

(54) RECORDING BODY, METHOD FOR PRODUCING RECORDING BODY, AND RECORDING METHOD

(71) Applicant: Takaki Hayashi, Shizuoka (JP)

(72) Inventor: Takaki Hayashi, Shizuoka (JP)

(73) Assignee: Ricoh Company, Ltd., Tokyo (JP)

(21) Appl. No.: 18/832,825

(22) PCT Filed: Jan. 26, 2023
(86) PCT No.: PCT/IB2023/050655

§ 371 Date: Jul. 24, 2024

(30) Foreign Application Priority Data
Jan. 28, 2022 (JP) 2022-011973
Dec. 22, 2022 (JP) 2022-205425

(51) Int. Cl. B41M 5/44; B41M 5/36

(52) U.S. Cl. CPC B41M 5/44; B41M 5/366; B41M 2205/40

(57) ABSTRACT

Provided is a recording body including a support body and a concealing layer containing a fusible substance and a binder, in which the fusible substance is a wax having a branched structure containing an aromatic ring.

### TECHNICAL FIELD

The present disclosure relates to a recording body, a method for producing a recording body, and a recording method.

### BACKGROUND ART

Conventionally, wax-type thermal recording paper, in which a colored layer and a concealing layer containing a fusible substance are laminated, is widely used as a thermal recording medium to form an image using the transparency of the concealing layer when the concealing layer is heated.

Examples of waxes that are the fusible substances, which have been proposed, include but are not limited to, low molecular weight polyethylene and carnauba wax (see, for example, PTLs 1 to 5), a higher fatty acid ester (see, for example, PTL 6), hydrogenated castor oil wax (natural wax, vegetable-based) (see, for example, PTL 7), aliphatic hydrocarbon paraffin (natural wax, petroleum-based) (see, for example, PTLs 8 and 9), certain natural wax and certain synthetic wax (see, for example, PTL 10). Examples of synthetic waxes that have been proposed include but are not limited to, polymethylene or polyethylene from methane or ethylene polymerization (see, for example, NPL 1).

### CITATION LIST

### Patent Literature

### [PTL 1]

Japanese Unexamined Patent Application Publication No. 07-290838

### [PTL 2]

Japanese Unexamined Patent Application Publication No. 08-073835

### [PTL 3]

Japanese Unexamined Patent Application Publication No. 08-183256

### [PTL 4]

Japanese Unexamined Patent Application Publication No. 08-183257

### [PTL 5]

Japanese Unexamined Patent Application Publication No. 63-141782

### [PTL 6]

Japanese Unexamined Patent Application Publication No. 2004-345111

### [PTL 7]

Japanese Patent No. 0252967

### [PTL 8]

Japanese Patent No. 0467966

### [PTL 9]

Japanese Patent No. 0488717

### [PTL 10]

Japanese Patent No. 0664015

### [Non Patent Literature 1]

### [NPL 1]

Toru Tomoshige, Hiroyasu Fujii, “Synthetic Waxes”, High Polymers, 1977, Vol. 26, September issue, pp. 637-642

### SUMMARY OF INVENTION

### Technical Problem

An object of the present invention is to solve various conventional problems and to provide a recording body having a high haze degree change ratio and excellent transmission during recording.

### Solution to Problem

A recording body according to embodiments of the present invention as means for solving the above-described problem is a recording body including a support body and a concealing layer containing a fusible substance and a binder, in which the fusible substance is a wax having a branched structure containing an aromatic ring.

### Advantageous Effects of Invention

According to embodiments of the present invention, a recording body having a high haze degree change ratio and excellent transmission during recording is provided.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1A is a schematic diagram illustrating an example of a recording body according to embodiments of the present invention.

FIG. 1B is a schematic diagram illustrating an other example of the recording body according to embodiments of the present invention.

FIG. 2A is a schematic diagram illustrating an other example of the recording body according to embodiments of the present invention.

FIG. 2B is a schematic diagram illustrating an other example of the recording body according to embodiments of the present invention.

FIG. 2C is a schematic diagram illustrating an other example of the recording body according to embodiments of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Image forming methods in the conventional technologies including the above-mentioned Patent Literatures 1 to 10 and Non-Patent Literature 1 are image forming methods that use, as a thermal recording body, a recording body in which a colored layer and a concealing layer containing a fusible substance are laminated and the concealing layer becomes transparent when the concealing layer is heated.

In other words, it is an image forming method that utilizes changes in the transmission (haze degree) and light transmittance of the concealing layer during recording (image formation). However, in these conventional proposals, in some cases, a degree of decrease of the haze degree of the concealing layer was small, and sufficient transmission could not be obtained during recording (image formation). Accordingly, sufficient sharpness could not be obtained when image formation was performed using a recording body including the concealing layer. As a result of intensive studies, the inventors of the present invention have found that the use of a wax having a branched structure containing an aromatic ring as the fusible substance contained in the concealing layer results in excellent transmission. The mechanism by which transmission is improved is not clear, but can be inferred that the following reason is responsible.

A compound that does not have a branched structure containing an aromatic ring easily forms an intermolecular arrangement of a straight chain structure and easily crystallizes. On the other hand, a compound that has a branched structure containing an aromatic ring has fewer crystallized parts, because the bulky branched structure inhibits the intermolecular arrangement of the straight chain structure. In other words, it is thought that reflection of light at particle interfaces is suppressed and transmission is increased by increasing amorphous parts and decreasing the particle interfaces.

Therefore, in the present disclosure, a recording body including a support body and a concealing layer containing a fusible substance and a binder, in which the fusible substance is a wax having a branched structure containing an aromatic ring, thereby obtaining a recording body having a high haze degree change ratio and excellent transmission during recording.

The following is a detailed description of the recording body in the present disclosure.

### (Recording Body)

The recording body of the present disclosure is a recording body including a support body and a concealing layer containing a fusible substance and a binder, and if desired, may have a colored layer and other layers.

### <Support Body>

A material of the support body is not particularly limited and can be appropriately selected according to a purpose. Examples of the material of the support body include, but are not limited to, polyethylene, polypropylene, polyester, polyamide, polystyrene, polyvinyl chloride (PVC), polyethylene terephthalate (PET), fabric (nylon, polyester, cotton, etc.), paper (synthetic paper, wash-resistant paper, lightweight coated paper, cast-coated paper, art paper, etc.).

A shape of the support body is not particularly limited and can be appropriately selected according to a purpose. Examples of the shape of the support body include, but are not limited to, a film, a laminated film, or a card shape with thickness.

A size and a structure of the support body are not particularly limited and can be appropriately selected according to a purpose.

Each of these may be used alone or in combination with others.

When the shape of the support body is a film, a surface treatment may be applied to a surface of the film.

Examples of the surface treatment include matting treatment, corona treatment, and metal deposition.

The support body may also be colored by including a colorant as described below.

### <Concealing Layer>

The concealing layer contains at least a fusible substance and a binder, and if desired, may contain an other component (A).

### «Fusible Substance»

The fusible substance is a wax having a branched structure containing an aromatic ring.

Herein, “branched structure” in this specification is defined as “a structure having a substituent group that is not hydrogen on a side chain relative to a main chain. The “main chain” indicates the longest straight chain, and the “side chain” indicates a molecular chain that is not the main chain.

Herein, “wax” in this specification is defined as “an organic substance that is solid or semi-solid at room temperature, melts in a temperature range from room temperature to about 100° C., has a low melt viscosity, and has a melting point but no softening point.” In other words, “wax” in this specification has a very low melt viscosity compared to general resins and easily changes shape above the melting point thereof.

Therefore, during non-recording (non-image forming), a base can be concealed by light scattering of void portions within the concealing layer, and during recording (image forming), the void portions within the concealing layer are filled and light scattering is suppressed, thereby increasing transmission.

A substance referred to as “resin” or “polymer” in this specification does not correspond to the wax.

The wax having a branched structure containing an aromatic ring refers to a wax containing a repeating unit represented by General Formula (1) below.

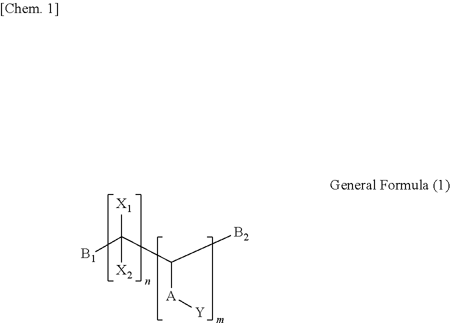

In General Formula (1), “A” is a bonding group, “B₁” and “B₂” are terminal groups, “X₁” and “X₂” are substituent groups, and “Y” is an aromatic ring group.

In General Formula (1), “n” and “m” represent repeating units, “n” is an integer from 0 to 1000 and “m” is an integer from 1 to 1000.

In General Formula (1), the bonding group “A” can be appropriately selected according to a purpose, with no particular limitations as long as it is a group connecting the main chain and the aromatic ring group. Examples of the bonding group “A” include, but are not limited to, a “—(CH₂)ₙ—” group (n=0 to 30), an alkoxy group, an ester group, an ether group, an azo group, a sulfide group, a disulfide group, an amide group, and a urea group.

Among the examples of the bonding group “A”, a “(—(CH₂)ₙ—” group (n=0 to 30), an ester group, an ether group are preferable from the viewpoint of ease of synthesis.

A single type of the bonding group “A” may be contained in the wax or a combination of two or more types of the bonding group “A” may be contained in the wax.

In General Formula (1), the terminal groups “B₁” and “B₂” are not particularly limited and can be appropriately selected according to a purpose. Examples of the terminal groups “B₁” and “B₂” include, but are not limited to, an alkyl group, a hydroxyl group, a carboxyl group, a sulfonyl group, an amino group, a nitro group, and a phenyl group. The terminal group “B₁” and the terminal group “B₂” may be the same or different, respectively.

In General Formula (1), the substituent group “X₁” and the substituent group “X₂” are not particularly limited and can be appropriately selected according to a purpose. Examples of the substituent group “X₁” and the substituent group “X₂” include, but are not limited to, a hydrogen group, a cyano group, an acid anhydride, a halogen group, a hydroxyl group, a carboxyl group, a sulfonyl group, an alkyl group, an alkenyl group, an alkynyl group, an amino group, a nitro group, an alkoxy group, an acetyl group, a formyl group, and an aldehyde group.

A single type of the substituent group “X₁” and the substituent group “X₂” may be contained in the wax or a combination of two or more types of the substituent group “X₁” and the substituent group “X₂” may be contained in the wax.

In General Formula (1), the aromatic ring group “Y” is not particularly limited and can be appropriately selected according to a purpose. Examples of the aromatic ring group “Y” include a phenyl group, an acene group, a pyridine group, a furan group, and a pyrrole group. A part of the aromatic ring group “Y” may be substituted with an alkyl group, a hydroxyl group, a phenyl group, a halogen group, a methoxy group, a sulfonyl group, a cyano group, an aldehyde group, etc. Among the examples of the aromatic ring group “Y”, a phenyl group and an acene group are preferable from the viewpoint of excellent transmission and sharpness. A single type of the aromatic ring group “Y” may be contained in the wax or a combination of two or more types of the aromatic ring group “Y” may be contained in the wax.

If a wax having a branched structure containing an aromatic ring is used as the fusible substance, the concealing layer containing the fusible substance can be changed into a transmissive layer having a high haze degree change ratio and excellent transmission. When the concealing layer is laminated together with a colored layer to be described later, a colored portion of the colored layer can be recognized in a portion of the concealing layer in which the haze degree thereof is low, and a colored portion of the colored layer is sufficiently concealed in a portion of the concealing layer in which the haze degree thereof is high, which results in a contrast difference and makes it possible to produce an image with high sharpness.

The “haze degree change ratio” in this specification is a ratio of a difference between a haze degree in a recording body before recording (before image formation) and a haze degree in the recording body after recording (after image formation) to the haze degree in the recording body before recording (before image formation).

Specifically, the “haze degree change ratio” can be calculated by the following formula. (Formula): (a haze degree in a recording body before recording—a haze degree in the recording body after recording)/the haze degree in the recording body before recording The haze degree change ratio is not particularly limited, but it is preferably 80% or higher, more preferably 85% or higher, and especially preferably 90% or higher.

An average particle diameter of the fusible substance is not particularly limited and can be appropriately selected according to a purpose, and the average particle diameter of the fusible substance is preferably 1.0 μm or more and 10.0 μm or less, and more preferably 2.0 μm or more and 7.0 μm or less.

If the average particle diameter of the fusible substance is 1.0 μm or more, it is suitable and possible to solve the problem that the concealment property decreases due to smaller voids between particles and the haze degree becomes lower during non-recording.

If the average particle diameter of the fusible substance is 10.0 μm or less, it is suitable and possible to solve the problem that unevenness on a surface of the concealing layer becomes large and a sufficiently low haze degree cannot be obtained during recording.

A method for measuring the average particle diameter is not particularly limited and can be appropriately selected according to a purpose, and an example thereof includes, but is not limited to, a method in which the average particle diameter can be determined from particle shapes of the fusible substance observed from a cross section of the recording body. In cross-sectional observation, a sample is prepared by a general method and a transmission electron microscope (TEM) may be used to measure the sample.

The measured value of the particle diameter of the fusible substance in the observation by TEM and the measured value of the particle diameter of a fusible substance in a concealing layer coating liquid used to form the concealing layer substantially coincide, and thus, a particle diameter distribution of the fusible substance after forming the concealing layer can be set by the particle diameter distribution of the fusible substance in the concealing layer coating liquid. A volume average particle diameter of the fusible substance in the concealing layer coating liquid can be measured, for example, by LA-960 (laser diffraction method, manufactured by HORIBA, Ltd.).

The melting point of the fusible substance is not particularly limited and can be appropriately selected according to a purpose, but the melting point thereof is preferably 40° C. or higher to 180° C. or lower.

If the melting point of the fusible substance is 40° C. or higher, it is possible to solve the problem that contrast of an image formed deteriorates due to an unnecessary decrease in the haze degree under a storage environment of the recording body.

If the melting point of the fusible substance is 180° C. or lower, it is suitable and possible to solve the problem that the fusible substance does not completely melt under an external stimulus during recording and transmission is deteriorated.

The wax having a branched structure containing an aromatic ring may be a product synthesized as appropriate, or a commercially available product.

Examples of the commercially available product of the wax having a branched structure containing an aromatic ring include, but are not limited to, 1160H (manufactured by Mitsui Chemicals, Inc.) and 1120H (manufactured by Mitsui Chemicals, Inc.) under trade names.

### «Binder»

The binder contained in the concealing layer is not particularly limited and can be appropriately selected according to a purpose. Examples of the binder include, but are not limited to, ethylene-vinyl acetate copolymer, partially saponified ethylene-vinyl acetate copolymer, ethylene-vinyl alcohol copolymer, ethylene-sodium methacrylate copolymer, polyamide, polyester, polyurethane, polyvinyl alcohol, methyl cellulose, carboxymethyl cellulose, starch, polyacrylic acid, isobutylene-maleic acid copolymer, styrene-maleic acid copolymer, polyacrylamide, polyvinyl acetal, polyvinyl chloride, polyvinylidene chloride, isoprene rubber, styrene-butadiene rubber, ethylene-propylene rubber, butyl rubber, and acrylonitrile-butadiene rubber. Among the examples of the binder, polyester, polyurethane, and polyacrylic acid are preferable from the viewpoint of excellent adhesiveness to the support body and excellent image durability.

Each of these may be used alone or in combination with others.

An added amount of the binder is not particularly limited and can be appropriately set according to a purpose. However, the added amount of the binder is preferably 5 parts by mass or more and 100 parts by mass or less, and more preferably 5 parts by mass or more and 70 parts by mass or less, with respect to 100 parts by mass of the fusible substance in the concealing layer.

If the added amount of the binder is 5 parts by mass or more with respect to 100 parts by mass of the fusible substance in the concealing layer, it is suitable and possible to solve the problem that adhesiveness to the support body becomes poor and peeling of the concealing layer occurs.

If the added amount of the binder is 100 parts by mass or less with respect to 100 parts by mass of the fusible substance in the concealing layer, the ratio of the fusible substance in the concealing layer decreases, and thus it is suitable and possible to solve the problem that the haze degree during recording increases and contrast of an image formed decreases.

### «An Other Component (A)»

The other component (A) is not particularly limited and can be appropriately selected according to a purpose. Examples of the other component (A) include, but are not limited to, a concealing aid, a melting aid, a dispersant, a colorant, and a photothermal conversion agent.

### Concealing Aid

The concealing aid is not particularly limited and can be appropriately selected according to a purpose. Examples of the concealing aid include, but are not limited to, titanium dioxide, zinc oxide, zinc sulfide, silicon oxide, barium sulfate, barium carbonate, and calcium sulfate.

### Melting Aid

The melting aid is not particularly limited and can be appropriately selected according to a purpose. Examples of the melting aid include, but are not limited to, a wax that is not the fusible substance mentioned above, and a monomeric organic hydrophobic substance. The wax that is not the fusible substance mentioned above is not particularly limited and can be appropriately selected according to a purpose. Examples of the wax include, but are not limited to, carnauba wax, beeswax, montan wax, paraffin wax, and synthetic wax. The monomeric organic hydrophobic substance is not particularly limited and can be appropriately selected according to a purpose. Examples of the monomeric organic hydrophobic substance include, but are not limited to, biphenyl, o-terphenyl, naphthalene, and anthracene. Each of these may be used alone or in combination with others.

### Dispersant

The dispersant is not particularly limited and can be appropriately selected according to a purpose. Examples of the dispersant include, but are not limited to, an anionic surfactant, a cationic surfactant, and a nonionic surfactant. Each of these may be used alone or in combination with others.

### Colorant

The colorant is not particularly limited and can be appropriately selected according to a purpose. Examples of the colorant include, but are not limited to, carbon black, azo dyes and pigments, phthalocyanine, quinacridone, anthraquinone, perylene, quinophthalone, aniline black, titanium oxide, zinc white, and chromium oxide.

Each of these may be used alone or in combination with others.

### Photothermal Conversion Agent

The photothermal conversion agent is not particularly limited and can be appropriately selected according to a purpose. Examples of the photothermal conversion agent include, but are not limited to, carbon black, graphite, phthalocyanine compounds, cyanine compounds, dithiol metal complexes, naphthoquinone compounds, diimmonium compounds, azo compounds, iron oxide, manganese sulfide, and cesium tungsten oxide.

An average thickness of the concealing layer is not particularly limited and can be appropriately selected according to a purpose, but the average thickness thereof is preferably 1 μm or more and 15.0 μm or less.

If the average thickness of the concealing layer is 1 μm or more, it is suitable and possible to solve the problem that the concealing layer itself becomes transparent and the haze degree in a non-transmissive portion increases, and thus the contrast of the image is reduced.

If the average thickness of the concealing layer is 15.0 μm or less, it is suitable and possible to solve the problem that heat is not sufficiently transferred during recording and the fusible substance in a transmissive portion is not completely melted, and thus transmission is poor.

The method for measuring the average thickness of the concealing layer is not particularly limited and can be appropriately selected according to a purpose, and an example thereof includes, but is not limited to, a method in which the average thickness of the concealing layer can be measured by observing a cross section of the concealing layer. Cross-sectional observation can be performed by preparing a sample in a general method and taking a cross-sectional TEM photograph using a transmission electron microscope (TEM, JEM-210, manufactured by JEOL Ltd.). The number of samples can be set to 10, and the average value of the samples can be used as the average thickness.

### <Colored Layer>

The colored layer contains a colorant and a binder, and if desired, may further contain an other component (B).

The other component (B) is not particularly limited and can be appropriately selected according to a purpose, and an example thereof includes, but is not limited to, a dispersant.

The colorant can be the same as that described in the above-mentioned-colorant-item, the binder can be the same as that described in the above-mentioned «Binder»item, and the dispersant can be the same as that described in the above-mentioned-dispersant-item, so the descriptions are omitted.

A method for forming the colored layer is not particularly limited and can be appropriately selected according to a purpose, and an example thereof includes, but is not limited to, a method in which the colored layer can be formed by applying a colored layer coating liquid containing the colorant, the binder, and further, if desired, the other component (B), onto the support body or the concealing layer by using an application method such as a gravure coater, a wire bar coater, a roll coater, or the like, and then, drying the applied coating.

### <Other Layers>

The other layer is not particularly limited and can be appropriately selected according to a purpose, and an example thereof includes, but is not limited to, an over layer.

### «Over Layer»

In the recording body of the present embodiment, the over layer may be provided on the concealing layer to improve head matching with a thermal head. However, if the over layer is provided, the over layer is preferably arranged so as not to hinder the efficient application of an external stimulus to the concealing layer.

The over layer is not particularly limited and can be appropriately selected according to a purpose, and examples thereof include, but are not limited to, the over layers exemplified in Japanese Patent No. 3657072, Japanese Patent No. 3616845, Japanese Patent No. 7073627, and Japanese Patent No. 7143952. Among the examples of the over layer, from the viewpoint of image protection durability, it is preferable to use the over layers exemplified in Japanese Patent No. 7073627 and Japanese Patent No. 7143952.

An average thickness of the over layer is not particularly limited and can be appropriately selected according to a purpose, but from the viewpoint of image protection and heat transfer from the thermal head, the average thickness thereof is preferably 0.01 μm or more and 50 μm or less.

A method for measuring the average thickness of the over layer is not particularly limited and can be appropriately selected according to a purpose, and an example thereof includes, but is not limited to, a method in which the average thickness of the over layer can be measured by observing a cross section of the over layer. Cross-sectional observation can be performed by preparing a sample in a general method and taking a cross-sectional TEM photograph using a transmission electron microscope (TEM, JEM-210, manufactured by JEOL Ltd.). The number of samples can be set to 10, and the average value of the samples can be used as the average thickness.

Here, an example of the recording body of the present embodiment will be described with reference to the drawings. However, the applications of the recording body of the present embodiment are not limited thereto.

In each drawing, the same reference numerals are given to the same components, and redundant explanation may be omitted. The number, position, shape, and the like of the constituent members described below are not limited to those in the present embodiment, and can be suitably set to a preferable number, position, shape, and the like in implementing the present embodiment.

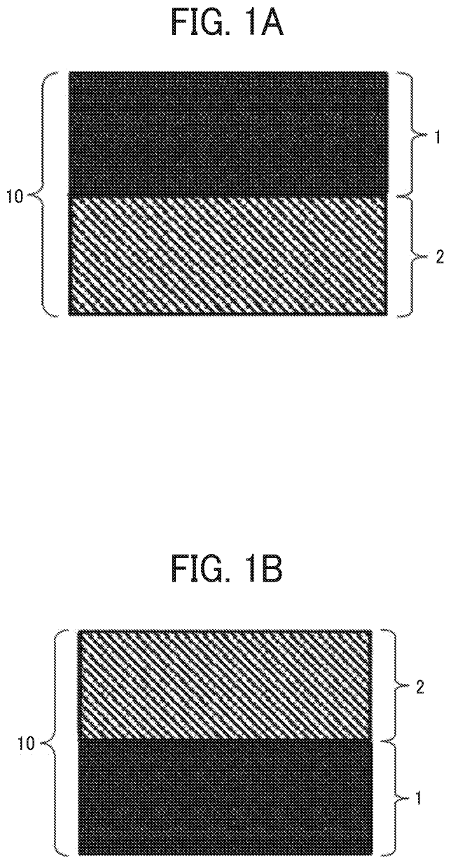

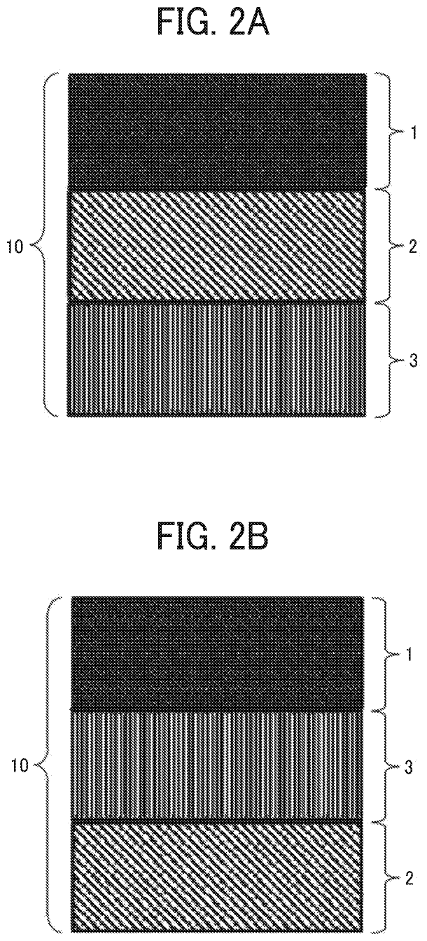

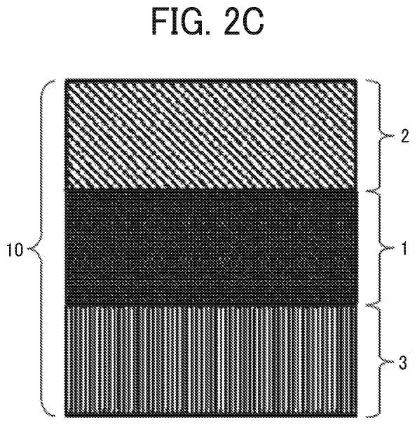

FIG. 1A is a schematic diagram illustrating an example of a recording body according to embodiments of the present invention, and FIGS. 1B to 2C each are schematic diagrams illustrating other examples of the recording body according to embodiments of the present invention.

A recording body 10 in FIG. 1A includes a support body 2 and a concealing layer 1 provided on the support body 2. The recording body 10 in FIG. 1B includes the concealing layer 1 and the support body 2 provided on the concealing layer 1.

In FIG. 2A, a colored layer 3 is provided on one side of the support body 2, and the concealing layer 1 is provided on a side of the support body 2 on which the colored layer 3 is not provided. In FIG. 2B, the support body 2, the colored layer 3, and the concealing layer 1 are laminated in this order. In FIG. 2C, the colored layer 3, the concealing layer 1, and the support body 2 are laminated in this order. An over layer may be provided on an upper surface of the concealing layer 1.

A layer structure of the recording body according to embodiments of the present invention may include, from the lowermost layer: (a) a concealing layer and a support body, (b) a support body and a concealing layer, (c) a concealing layer, a support body, and a colored layer, (d) a concealing layer, a colored layer, and a support body, or (e) a support body, a concealing layer, and a colored layer.

### (Method for Producing Recording Body)

The method for producing the recording body according to embodiments of the present invention includes a concealing layer forming process in which a concealing layer coating liquid is applied onto a substrate, and if desired, may include other processes.

The “concealing layer” is the same as that described in the above section (Recording Body) item, so the description is omitted.

### <Concealing Layer Forming Process and Concealing Layer Formation Device>

The concealing layer forming process is a process of applying a concealing layer coating liquid onto a substrate. The concealing layer forming process can be suitably implemented by a concealing layer formation device.

The concealing layer forming process may include other processes as necessary. The other processes can be suitably implemented by other devices.

Here, the substrate refers to the <Support Body> or <Colored Layer> described in the above-mentioned (Recording Body) item. The <Support Body> and the <Colored Layer> are the same as those described in the above-mentioned (Recording Body) item, so the descriptions are omitted.

Here, the concealing layer coating liquid is a material for the <Concealing Layer> described in the above-mentioned (Recording Body) item, that is, containing the «Fusible Substance» and the «Binder», and if desired, containing the <An Other Component (A)>. The «Fusible Substance», the «Binder», and the <An Other Component (A)> are the same as those described in the above-mentioned (Recording Body) item, so the descriptions are omitted.

A method for producing the concealing layer coating liquid is not particularly limited and can be appropriately selected according to a purpose, and an example thereof includes, but is not limited to, the following method.

A wax having a branched structure containing an aromatic ring, as a fusible substance, is added to ethanol and the obtained mixture was subjected to wet pulverization by using a dispersing machine (for example, six-cylinder dispersing machine, manufactured by IMEX Co.,Ltd.), thereby preparing a wax dispersion liquid. The wax dispersion liquid can be mixed with the «Binder» and, if desired, the <An Other Component (A)> to prepare a concealing layer coating liquid.

The concealing layer formation device is a device that applies a concealing layer coating liquid onto a substrate. The concealing layer formation device is not particularly limited and can be appropriately selected according to a purpose, and an example thereof includes, but is not limited to, a coating device using a gravure coater, a wire bar coater, or a roll coater.

### <Other Processes and Other Devices>

The other processes include a drying process. The other devices include a drying device. The drying process can be suitably implemented by the drying device.

### (Recording Method)

The recording method according to embodiments of the present invention is a recording method for recording on a recording body, in which an image is formed by utilizing a contrast between a hue of a colored layer in the recording body and a hue of a concealing layer in the recording body.

Specifically, the recording method is a method in which the fusible substance contained in the concealing layer is melted by an external stimulus, so that the transparency of the concealing layer increases, and an image is formed based on a contrast difference between a transmissive portion and a non-transmissive portion.

The recording body is the same as the above-mentioned recording body having a colored layer, so the description is omitted.

The external stimulus is not particularly limited and can be appropriately selected according to a purpose, and examples thereof include, but are not limited to, heat, light, electromagnetic waves, and pressure.

If the external stimulus is heat, the heating device can be a thermal pen or a thermal head. If the recording body contains a photothermal conversion agent, it is also possible to form an image using laser light.

Specific examples of the recording method include a method in which a white opaque fusible substance is applied as a concealing layer on the support body or an upper surface of the colored layer, and a heating body such as a thermal pen is applied to the fusible substance to melt the fusible substance on the surface, thereby developing the colored layer. In this case, compared with a thermosensitive color development method using a dye and the like, the present method is strongly advantageous in terms of light resistance, temperature and humidity resistance, and the like, and mono-color development is possible by changing the color of the colored layer.

### EXAMPLES

Examples according to embodiments of the present invention will be described below, but the scope of the present invention is in no way limited to such examples. In the following Examples and Comparative Examples, “parts” and “%” refer to “parts by mass” and “mass %”, unless otherwise specified.

### Example 1

### <Preparation of Concealing Layer Coating Liquid>

A wax having a branched structure containing an aromatic ring (1160H, manufactured by Mitsui Chemicals, Inc.) was added as a fusible substance to ethanol to obtain a solid content of 20 mass %. The obtained mixture was subjected to wet pulverization by using a six-cylinder dispersing machine (manufactured by IMEX Co.,Ltd.), thereby preparing a wax dispersion liquid. A laser scattering/diffraction particle diameter distribution analyzer (LA-960, manufactured by Horiba, Ltd.) was used to confirm that the wax in the wax dispersion liquid was pulverized to a volume average particle diameter of 5 μm or less. Next, 100 parts of the wax dispersion liquid and 5 parts of a polyacrylic acid aqueous solution (manufactured by BASF Japan Ltd., solid content of 34 mass %) were mixed to obtain a concealing layer coating liquid.

### <Application of Concealing Layer Coating Liquid>

A polyester film (LUMIRROR, manufactured by Toray Industries, Inc.) having an average thickness of 20.0 μm was used as a support body. The concealing layer coating liquid was applied to one side of the polyester film and dried at 40° C. for 30 seconds to form a concealing layer having an average thickness of 7.0 μm, thereby obtaining a recording body.

### <Measurement of Average Particle Diameter of Fusible Substance in Concealing Layer>.

The average particle diameter of the fusible substance in the concealing layer was determined from particle shapes of the fusible substance observed from a cross section of the concealing layer. In cross-sectional observation, a sample is prepared by a general method, and a cross-sectional TEM photograph is taken by a transmission electron microscope (TEM, JEM-210, manufactured by JEOL Ltd.). Particle diameters of five fusible substance particles in the cross-sectional TEM photograph were measured, and the average value of the measurements was used as the average particle diameter of the fusible substance.

### <Measurement of Average Thickness>

An average thickness of each layer was determined by observing a cross section of each layer. In cross-sectional observation, a sample is prepared by a general method, and a cross-sectional TEM photograph is taken by a transmission electron microscope (TEM, JEM-210, manufactured by JEOL Ltd.). The number of samples was 10, and the average value of the samples was used as the average thickness.

### (Examples 2 to 3 and Comparative Examples 1 to 5)

Recording bodies of Examples 2 to 3 and Comparative Examples 1 to 5 were prepared similarly as in Example 1, except that, in the <Preparation of Concealing Layer Coating Liquid>, the fusible substances were changed as illustrated in Table 1 to 2. An oxidized polyethylene wax of Comparative Example 5 is a wax that does not contain an aromatic ring but has a branched structure.

### Examples 4 to 5

Recording bodies of Examples 4 to 5 were prepared similarly as in Example 1, except that, in the <Preparation of Concealing Layer Coating Liquid>, the waxes were changed to those obtained from the following synthesis examples 1 to 2.

### Synthesis Example 1: Synthesis of Wax Having Branched Structure Containing Aromatic Ring of Example 4

100 g of an ethylene polymer wax (HP10A, manufactured by Mitsui Chemicals, Inc.) was heated to 160° C. and melted with stirring. Next, 35 g of 1-ethenyl-4-ethoxybenzene (manufactured by Sigma-Aldrich Japan) in a molten state and 6 g of di-tert-butylperoxide (manufactured by Sigma-Aldrich Japan) were added dropwise over a period of 2 hours while the temperature was maintained. After the drop was completed, a reaction was allowed to proceed for another 1 hour, and then volatiles were removed by a deaeration treatment in vacuum (10 mmHg) for 1 hour in the molten state. Then, after being cooled, the wax having a branched structure containing an aromatic ring of Example 4 was obtained.

### Synthesis Example 2: Synthesis of Wax Having Branched Structure Containing Aromatic Ring of Example 5

A wax having a branched structure containing an aromatic ring of Example 5 was obtained in the same way, except that 1-ethenyl-4-ethoxybenzene in Synthesis Example 1 was changed to 4-ethenyl-1,1′-biphenyl (manufactured by Sigma-Aldrich Japan).

TABLE 1

| | Fusible substance | | Resin |
|---|---|---|---|
| | | A structure having or not having | An added amount with respect |
| | | a branched structure containing | to 100 parts by mass of wax |
| | | an aromatic ring | (parts by mass) |
| Example 1 | A wax having a branched structure containing an aromatic ring (1160H, manufactured by Mitsui Chemicals, Inc., melting point 104° C., average particle diameter 5 μm) | having 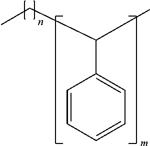 | 5 |
| Example 2 | A wax having a branched structure containing an aromatic ring (1160H, manufactured by Mitsui Chemicals, Inc., melting point 104° C., average particle diameter 5 μm) | having 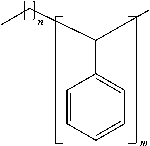 | 70 |
| Example 3 | A wax having a branched structure containing an aromatic ring (1120H, manufactured by Mitsui Chemicals, Inc., melting point 107° C., average particle diameter 5 μm) | having 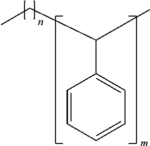 | 100 |
| Example 4 | A wax having a branched structure containing an aromatic ring (synthesis example 1, melting point 120° C., average particle diameter 5 μm) | having 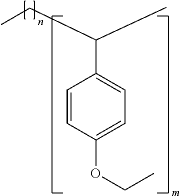 | 35 |
| Example 5 | A wax having a branched structure containing an aromatic ring (synthesis example 2, melting point 123° C., average particle diameter 5 μm) | having 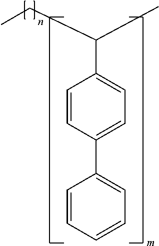 | 35 |

TABLE 2

| | Fusible substance | | Resin |
|---|---|---|---|
| | | A structure having or not | An added amount with respect |
| | | having a branched structure | to 100 parts by mass of wax |
| | | containing an aromatic ring | (parts by mass) |
| Comparative Example 1 | A non-polar polymethylene wax (FNP-0090, NIPPON SEIRO CO., LTD., melting point 90° C., average particle diameter 5μm) | not having 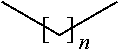 | 35 |
| Comparative Example 2 | A non-polar polyethylene wax (HP10A, Mitsui Chemicals, Inc., melting point 116° C., average particle diameter 5 μm) | not having 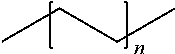 | 35 |
| Comparative Example 3 | A non-polar polyethylene wax (200PF, Mitsui Chemicals, Inc., melting point 122° C., average particle diameter 5 μm) | not having 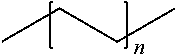 | 70 |
| Comparative Example 4 | A styrene polymer (TECHPOLYMER, Sekisui Kasei Co., Ltd., average particle diameter 4μm) | having | 35 |
| Comparative Example 5 | An oxidized polyethylene wax (210MP, Mitsui Chemicals, Inc., melting point 112° C., average particle diameter 5 μm) | not having | 35 |

### [Evaluation of Transmission]

The recording bodies of Examples 1 to 5 and Comparative Examples 1 to 5 were heated on a 120° C. hot plate for 30 seconds from a non-coated surface of the concealing layer, and then cooled at room temperature for 30 seconds. Then, measurements were made by using a haze meter (HZ-1, manufactured by Suga Test Instruments Co., Ltd.) and evaluated according to the following evaluation criteria. The results are presented in Table 3.

### Evaluation Criteria

Good: haze degree is less than 20
Poor: haze degree is 20 or more

### [Evaluation of Sharpness]

### <Preparation of Colored Layer Coating Liquid>

100 parts of carbon black (manufactured by Mitsubishi Chemical Corporation) as a colorant and 150 parts of a polyacrylic acid aqueous solution (manufactured by BASF Japan Ltd., solid content of 34 mass %) were added to ethanol so that the solid content was 30 mass %. The obtained mixture was subjected to wet pulverization by using a six-cylinder dispersing machine (manufactured by IMEX Co.,Ltd.), and a laser scattering/diffraction particle diameter distribution analyzer (LA-960, manufactured by Horiba, Ltd.) was used to confirm that the carbon black was pulverized to a volume average particle diameter of 0.2 μm or less, to obtain the colored layer coating liquid.

### <Application of Colored Layer Coating Liquid>

In the recording bodies of Examples 1 to 5 and Comparative Examples 1 to 5, the colored layer coating liquid was applied to a surface of the support body on which the concealing layer coating liquid was not applied and dried at 40° C. for 30 seconds to form a colored layer with an average thickness of 1 μm.

The recording bodies of Examples 1 to 5 and Comparative Examples 1 to 5 were heated on a 120° C. hot plate for 30 seconds from a non-coated surface of the concealing layer, and then cooled at room temperature for 30 seconds. Then, measurements were made by using a reflection densitometer (Spectrodensitometer, x-rite, Inc.) and evaluated according to the following evaluation criteria.

### Evaluation Criteria

Good: reflection density value is 1.20 or more
Poor: reflection density value is less than 1.20

TABLE 3

| | Transmission | | | | | | |
|---|---|---|---|---|---|---|---|
| | | | [before heating] − | | | | |
| | | | [after heating] | Haze degree | | Sharpness | |
| | Haze degree | Haze degree | Haze degree | change | | Reflection | |
| | (before heating) | (after heating) | difference | ratio | Evaluation | density value | Evaluation |
| Example 1 | 94.6 | 8.5 | 86.1 | 91% | Good | 1.30 | Good |
| Example 2 | 93.2 | 10.2 | 83 | 89% | Good | 1.26 | Good |
| Example 3 | 95 | 18.2 | 76.8 | 81% | Good | 1.20 | Good |
| Example 4 | 90.8 | 12.4 | 78.4 | 86% | Good | 1.21 | Good |
| Example 5 | 93 | 9.1 | 83.9 | 90% | Good | 1.28 | Good |
| Comparative | 94.2 | 60.9 | 33.3 | 35% | Poor | 1.10 | Poor |
| Example 1 | | | | | | | |
| Comparative | 92.9 | 76.5 | 16.4 | 18% | Poor | 1.05 | Poor |
| Example 2 | | | | | | | |
| Comparative | 94.3 | 79 | 15.3 | 16% | Poor | 1.00 | Poor |
| Example 3 | | | | | | | |
| Comparative | 5.7 | 5.6 | 0.1 | 2% | Poor | — | — |
| Example 4 | | | | | | | |
| Comparative | 93.3 | 64.4 | 28.9 | 31% | Poor | 1.09 | Poor |
| Example 5 | | | | | | | |

From the results in Table 3, it was found that, in the recording bodies of Examples 1 to 5, higher transmission and higher sharpness were obtained than in the recording bodies of Comparative Examples 1 to 3 and 5. The recording bodies of comparative Example 4 had high transmission before heating, and transmits the base. As a result, no change was seen between before heating and after heating, so the recording body of Comparative Example 4 did not constitute a body as a recording body.

### Application Example 1

### <Preparation of Concealing Layer Coating Liquid>

A wax having a branched structure containing an aromatic ring (1160H, manufactured by Mitsui Chemicals, Inc.) was added as a fusible substance to ethanol to obtain a solid content of 20 mass %. The obtained mixture was subjected to wet pulverization by using a six-cylinder dispersing machine (manufactured by IMEX Co.,Ltd.), thereby preparing a wax dispersion liquid. A laser scattering/diffraction particle diameter distribution analyzer (LA-960, manufactured by Horiba, Ltd.) was used to confirm that the wax in the wax dispersion liquid was pulverized to a volume average particle diameter of 5 μm or less.

100 parts of cesium tungsten oxide (manufactured by Sumitomo Metal Mining Co., Ltd.) as a photothermal conversion agent and 50 parts of polyacrylic acid (manufactured by BASF Japan Ltd.) were added to ethanol so that the solid content was 20 mass %. The obtained mixture was subjected to wet pulverization by using a six-cylinder dispersing machine (manufactured by IMEX Co.,Ltd.), thereby preparing a cesium tungsten oxide dispersion liquid. A laser scattering/diffraction particle diameter distribution analyzer (LA-960, manufactured by Horiba, Ltd.) was used to confirm that the cesium tungsten oxide in the cesium tungsten oxide dispersion liquid was pulverized to a volume average particle diameter of 0.1 μm or less.

Next, 100 parts of the wax dispersion liquid, 0.5 parts of the cesium tungsten oxide dispersion liquid, and 6 parts of a polyacrylic acid aqueous solution (manufactured by BASF Japan Ltd., solid content of 34 mass %) were mixed to obtain a concealing layer coating liquid.

### <Application of Concealing Layer Coating Liquid>

A polyester film (LUMIRROR, manufactured by Toray Industries, Inc.) having an average thickness of 20.0 μm was used as a support body. The concealing layer coating liquid was applied to one side of the polyester film and dried at 40° C. for 30 seconds to form a concealing layer having an average thickness of 7.0 μm, thereby obtaining a recording body.

### [Evaluation of Transmission]

A semiconductor laser device equipped with a semiconductor laser LIMO25-F100-DL808 (center wavelength: 808 nm, manufactured by Limo Inc.) was used as a semiconductor laser light source to record an image of the above-described recording bodies by adjusting an emission distance to 152 mm and a linear velocity to 1000 mm/s. At this time, images were recorded so that a recording energy was 5 mJ/mm² to 30 mJ/mm², and a recording energy at which the density is a saturated density was defined as a saturated recording energy. The recorded recording body was measured by using a haze meter (HZ-1, manufactured by Suga Test Instruments Co., Ltd.) and evaluated according to the following evaluation criteria. The results are presented in Table 4.

### Evaluation Criteria

Good: haze degree is less than 20
Poor: haze degree is 20 or more

TABLE 4

| | Transmission |
|---|---|
| Application Example 1 | Good (12.0) |

From the results in Table 4, it was found that the recording body of Application Example 1 had high transmission.

Embodiments of the present invention include the following items <1> to <8>.
<1> A recording body including a support body and a concealing layer containing a fusible substance and a binder, in which the fusible substance is a wax having a branched structure containing an aromatic ring.
<2> The recording body according to <1>, in which the fusible substance contains a repeating unit represented by the following general formula (1).

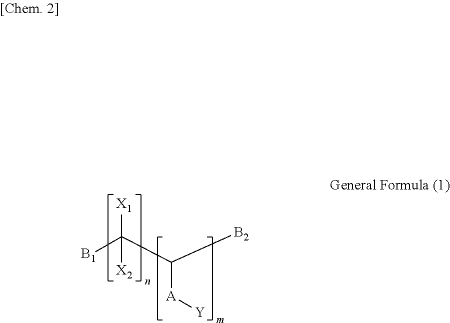

In general formula (1), “A” is a bonding group, “B₁” and “B₂” are terminal groups, “X₁” and “X₂” are substituent groups, “Y” is an aromatic ring group, “n” is an integer from 0 to 1000, and “m” is an integer from 1 to 1000.
<3> The recording body according to <2>, in which the aromatic ring group is either a phenyl group or an acene group.
<4> The recording body according to any one of <1> to <3>, in which an average particle diameter of the fusible substance is 1.0 μm or more and 10.0 μm or less.
<5> The recording body according to any one of <1> to <4>, in which a content of the binder is 5 parts by mass or more and 100 parts by mass or less with respect to 100 parts by mass of the fusible substance in the concealing layer.
<6> The recording body according to any one of <1> to <5> further including a colored layer.
<7> A method for producing a recording body comprising applying a concealing layer coating liquid onto a substrate.
<8> A recording method comprising forming an image on the recording body according to <6> by utilizing a contrast between a hue of the colored layer and a hue of the concealing layer.

According to the recording body described in <1> to <6>, the method for producing the recording body described in <7>, and the recording method described in <8>, various conventional problems can be solved and the object of the present invention can be achieved.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application Nos. 2022-011973 and 2022-205425, filed on Jan. 28, 2022 and Dec. 22, 2022, respectively, in the Japan Patent Office, the entire disclosure of each of which is hereby incorporated by reference herein.

### REFERENCE SIGNS LIST

1: Concealing layer
2: Support body
3: Colored layer
10: Recording body

1. A recording body, comprising:
a support body; and
a concealing layer containing a fusible substance and a binder, the fusible substance being a wax having a branched structure containing an aromatic ring.

2. The recording body according to claim 1, wherein the fusible substance contains a repeating unit represented by formula (1): 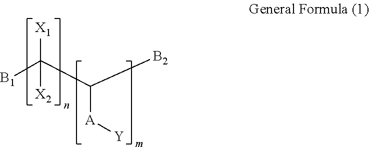
where, in formula (1), “A” is a bonding group, “B₁” and “B₂” are terminal groups, “X₁” and “X₂” are substituent groups, “Y” is an aromatic ring group, “n” is an integer from 0 to 1000, and “m” is an integer from 1 to 1000.

3. The recording body according to claim 2, wherein the aromatic ring group is either a phenyl group or an acene group.

4. The recording body according to claim 1, wherein an average particle diameter of the fusible substance is 1.0 μm or more and 10.0 μm or less.

5. The recording body according to claim 1, wherein a content of the binder is 5 parts by mass or more and 100 parts by mass or less with respect to 100 parts by mass of the fusible substance in the concealing layer.

6. The recording body according to claim 1, further comprising a colored layer.

7. A method for producing a recording body, comprising:
applying a concealing layer coating liquid onto a substrate.

8. A recording method, comprising:
forming an image on the recording body according to claim 6 utilizing a contrast between a hue of the colored layer and a hue of the concealing layer.
